(19) United States
(12) Patent Application Publication
(10) Pub. No.: US 2025/0165703 A1
(43) Pub. Date: May 22, 2025

(54) MERGING MISIDENTIFIED TEXT STRUCTURES IN A DOCUMENT

(71) Applicant: Adobe Inc., San Jose, CA (US)

(72) Inventors: Shwetha S, Tamil Nadu (IN); Jayant Vaibhav SRIVASTAVA, Varanasi (IN); Dinesh AGARWAL, Delhi (IN); Aparna GARIMELLA, Hyderabad (IN); Anandhavelu N, Bangalore (IN)

(73) Assignee: Adobe Inc., San Jose, CA (US)

(21) Appl. No.: 18/511,111

(22) Filed: Nov. 16, 2023

(51) Int. Cl. G06F 40/174; G06F 40/109; G06F 40/40

(52) U.S. Cl. CPC G06F 40/174; G06F 40/109; G06F 40/40

(57) ABSTRACT

Embodiments are disclosed for merging misidentified text structures. The method may include receiving a document including a plurality of text elements. The method may further include determining, by a machine learning model, a likelihood of merging a first text element of the plurality of text elements with a second text element of the plurality of text elements based on structure data and context data associated with the first and second text elements. The method may further include determining whether the likelihood of merging the first text element with the second text element satisfies a threshold. The method further includes responsive to determining that the likelihood of merging the first text element with the second text element satisfies the threshold, merging the first text element with the second text element.

### BACKGROUND

Unstructured data includes data stored without metadata or a predetermined format. For example, unstructured data may include data in any format, in contrast to structured data that is formatted according to a predetermined format. Examples of unstructured data include portable document format (PDF) documents in which the data contained within the PDF lacks a predefined structure. For example, a PDF can include text, graphics, tables, charts, and more in a single file format. The PDF is a versatile file format that reliably presents data across various types of computing devices. PDFs are reliable because they preserve the integrity of data contained in the document at the expense of the structure of the data.

While PDFs are generally used for viewing documents, PDFs can also be edited. When a PDF document is edited, PDF elements (e.g., text, graphics, tables, charts, etc.) are extracted from the PDF. Because the PDF is unstructured, there is a need to identify structural information of the PDF, such as boundaries of text.

### SUMMARY

Introduced here are techniques/technologies that merge misidentified text structures by performing PDF boundary detection tasks. A structural merger system described herein evaluates the structure of text, and in particular, text boundaries, to determine whether text boundaries should be merged. The structural merger system leverages information detected in a PDF such as font information, distance information, and heuristics, to merge misidentified text boundaries. Text boundaries evaluated by the structural merger system include formatting boundaries such as a paragraph format, a heading format, a sentence format, and the like.

More specifically, in one or more embodiments, a heading manager of the structural merger system evaluates multiple text headings to determine whether one or more of the multiple text headings should be merged into a single text heading. For example, the heading manager identifies candidate headings associated with a target heading to determine whether the candidate headings should be merged with the target heading. Candidate headings that are in close proximity with the target heading, are contextually related to the target heading, and share font characteristics with the target heading are likely to be merged by the heading manager. A machine learning model of the heading manager determines the likelihood that the candidate headings should be merged with the target heading.

A paragraph manager of the structural merger system evaluates multiple paragraphs to determine whether one or more of the multiple paragraphs should be merged into a single paragraph. For example, the paragraph manager identifies a target incomplete paragraph using heuristics and determines whether candidate incomplete paragraphs should be merged with the target incomplete paragraph, based on the context of the target incomplete paragraph and the candidate incomplete paragraph.

Additional features and advantages of exemplary embodiments of the present disclosure will be set forth in the description which follows, and in part will be obvious from the description, or may be learned by the practice of such exemplary embodiments.

### BRIEF DESCRIPTION OF THE DRAWINGS

The detailed description is described with reference to the accompanying drawings in which:

FIG. 1 illustrates a diagram of a process of merging misidentified text structures in a document, in accordance with one or more embodiments;

FIG. 2 illustrates an example PDF document with misidentified headings, in accordance with one or more embodiments;

FIG. 3 illustrates an example PDF document with misidentified paragraphs, in accordance with one or more embodiments;

FIG. 4 illustrates a diagram of a process of merging headings using the heading manager, in accordance with one or more embodiments;

FIG. 5 illustrates a diagram of a process of merging paragraphs using the paragraph manager, in accordance with one or more embodiments;

FIG. 6 illustrates obtaining training data used to train a language model, in accordance with one or more embodiments;

FIG. 7 illustrates positive heading pairs and negative heading pairs, in accordance with one or more embodiments;

FIG. 8 illustrates an example process of supervised learning used to train a machine learning model, in accordance with one or more embodiments;

FIG. 9 illustrates a schematic diagram of the structural merger system in accordance with one or more embodiments;

FIG. 10 illustrates a flowchart of a series of acts in a method of merging misidentified text structures in accordance with one or more embodiments; and

FIG. 11 illustrates a block diagram of an exemplary computing device in accordance with one or more embodiments.

### DETAILED DESCRIPTION

One or more embodiments of the present disclosure include a structural merger system that merges misidentified text structures such as headings and paragraphs. In some conventional approaches, structures of text are identified using heuristics or tokenizers. For example, one conventional approach involves detecting the presence of a period to identify the end of a sentence in a paragraph. A different conventional approach uses sentence tokenizers such as those in Natural Language Toolkit (NLTK) to identify the end of a sentence in a paragraph. However, these approaches may misidentify structures of the document when the document is unstructured, such as a PDF. For example, identifying structures in unstructured documents (e.g., documents with embedded figures and/or unique formats such as invoices, brochures, and the like) using such conventional systems may result in misidentified structures because such systems are often used in structured free-flowing text documents.

Other conventional methods identify structural information of a PDF by grouping data heuristically (e.g., grouping text in a paragraph based on the distance of the sentences in the paragraph, grouping text as a heading based on the position of the text in the document, etc.). However, the grouped data is error prone in the sense that formatting boundaries are misidentified. For example, a single paragraph continued on multiple columns or pages (e.g., a paragraph starting on a first page and continued to the second page) can be misidentified as two paragraphs. In other words, the single paragraph is incorrectly split into two paragraphs.

To address these and other deficiencies in conventional systems, the structural merger system of the present disclosure performs PDF sentence boundary detection tasks to detect multiple text structures (e.g., sentences, paragraphs, headings, etc.) in a PDF document and evaluates the detected text structures. Text structures are evaluated using both structure information and contextual information to determine whether the text structures should be merged.

The merging of misidentified text structures improves how the PDF is edited. For example, text structures that have been misidentified may be edited multiple times (e.g., editing a first text structure and subsequently editing the second text structure). Merging text structures that have been misidentified increases a user experience because a single text structure can be edited without needing to edit multiple text structures. As a result, computing resources, such as power, are conserved because less time is spent editing and/or manually merging the misidentified text structures.

Additionally, merging misidentified text structures improves the accuracy of downstream processes that depend on the identification of text structure boundaries. For example, one or more downstream processes like reflow, which is used to adjust the properties of documents to be displayed on various computing devices, uses text structure boundaries to reorganize the information of the document. Reorganizing the information of the document using the text structure boundaries maintains the readability of the reorganized document as compared to the original document (e.g., in terms of informational flow of the document). Merging text structures that have been misidentified improves the accuracy of subsequent downstream processes, conserving computing resources associated with correcting the misidentified text structures.

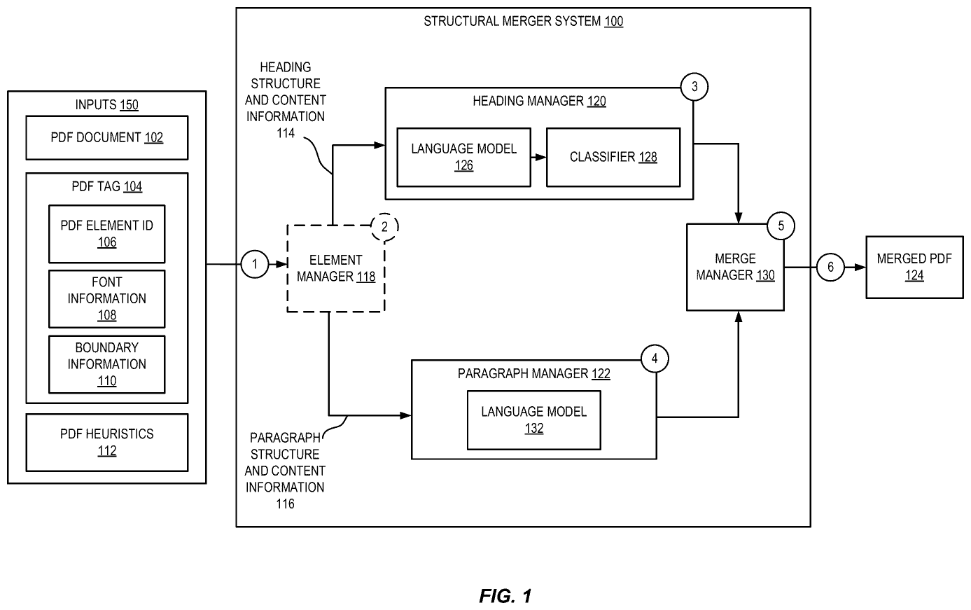

FIG. 1 illustrates a diagram of a process of merging misidentified text structures in a document, in accordance with one or more embodiments. In some embodiments, structural merger system 100 may be implemented as part of a natural language processing (NLP) suite of software. In some embodiments, a user may access the NLP system including the structural merger system 100 via a client application executing on their computing device (e.g., a desktop, laptop, mobile device, etc.). In some embodiments, the client application (or “app”) may be an application provided by the NLP system (or a service provider corresponding to the NLP system or other entity). Additionally, or alternatively, the user may access the NLP system via a browser-based application executing in a web browser installed on the user's computing device.

In some embodiments, the NLP system is initiated to, for example, recognize text in PDF document 102 or edit PDF document 102. A user provides the PDF document 102 to be processed by the NLP system by uploading the PDF document 102 to the NLP system directly or uploading the PDF document 102 to a cloud-based storage location (or other Internet-accessible storage location) and providing a reference (e.g., a URL, URI, or other reference) to the PDF document 102 to the NLP system. Additionally, or alternatively, the NLP system including the structural merger system 100 may be implemented entirely or in part on the user's computing device. As a result of some processes performed by the NLP system, PDF tags 104 are determined. For example, one or more NLP text segmentation tasks are performed in the NLP system to identify PDF tags 104 of the PDF document 102.

The structural merger system 100 is able to perform two boundary detection tasks of a PDF document. The heading manager 120 evaluates the boundary of headings to determine whether multiple headings in a received document should be merged into a single heading. The paragraph manager 122 evaluates the boundary of paragraphs to determine whether multiple paragraphs in the received document should be merged into a single paragraph. While the structural merger system 100 described herein performs two boundary detection tasks (e.g., evaluating the boundaries of headings and paragraphs), it should be appreciated that the structural merger system 100 can deploy other managers (not shown) to detect boundaries of other text structures (e.g., sentences). Similarly, for ease of description, the structural merger system 100 is described as merging misidentified text structures of PDF document 102, however other documents can be considered. For example, the structural merger system 100 may be used with any unstructured document type or structured document type.

As shown at numeral 1, inputs 150 are provided to structural merging system 100 to initiate the process of merging misidentified text structures. As described above, the inputs 150 include the PDF document 102 and PDF tag 104 determined by one or more processes of the NLP system. The PDF document 102 is a digital document including PDF elements such as text, figures, tables, charts, and the like in an unstructured data format.

The PDF tag 104 includes information about a corresponding tagged PDF element. In some embodiments, the structural merger system 100 receives a tree representation of PDF tags 104, where the tree representation hierarchically arranges the PDF tags 104 in a structure. The tree representation provides structure to the unstructured PDF document 102. For example, the order of PDF tags 104 arranged in the tree is based on the order that the corresponding PDF elements are rendered/displayed in the PDF document 102. The PDF tags 104 may be obtained from any one or more upstream processes. For example, one or more object detection processes can provide PDF tags 104.

In some embodiments, the PDF tag 104 can include a PDF element ID 106 that identifies each PDF element. For example, the PDF element ID 106 can label text structures (e.g., headings, paragraphs), graphics, tables, as corresponding PDF text elements, PDF graphic elements, PDF table elements, and the like.

The PDF tag 104 can also include font information 108 about PDF text elements. The font information 108 indicates the font of the corresponding tagged PDF text element. In some embodiments, the font information 108 includes a geometric outline information of each glyph (e.g., a shape or a character of text) in the font associated with the PDF element. In some embodiments, font information 108 includes a boldness of a font (or a font weight) associated with the PDF element, which can be a value ranging from 0-7. In some embodiments, the font information 108 is determined by the structural merger system 100. For example, one or more components of the structural merger system 100 (not shown) may compare a text of a PDF text element in the PDF document 102 to a catalogue of fonts. The one or more components are able to determine font information 108 by performing template-based matching (e.g., comparing pixels in the text of the PDF element to pixels of text in various fonts stored in the catalogue of fonts).

In some embodiments, boundary information 110 can also be included in the PDF tag 104. The boundary information 110 can include information to locate the tagged PDF element. In some embodiments, the boundary information 110 can include a bounding box encompassing the tagged PDF element.

Inputs 150 can also include PDF heuristics 112. A heuristic manager (not shown) scans strings of text in PDF document 102 to search for predetermined conditions. In operation, text associated with PDF tags 104 is evaluated for one or more predetermined conditions (e.g., PDF heuristics 112). For example, the PDF heuristics 112 can indicate whether a tagged PDF element includes a full stop by identifying termination conditions such as “.”, “!”, and “?” in strings of text of the tagged PDF element.

At numeral 2, an element manager 118 routes PDF text elements to corresponding managers of the structural merger system 100. In operation, the element manager 118 determines whether a text element, identified via a PDF element ID 106 of a PDF tag 104, is a heading. Responsive to determining that a PDF element ID 106 indicates a heading text element, the element manager 118 routes heading structure and content information 114 associated with the heading text element to the heading manager 120. In some embodiments, the heading structure information can include font information 108 and boundary information 110. The heading content information can include the content of the tagged PDF heading element obtained from the PDF document 102.

Similarly, the element manager 118 determines whether a text element, identified via a PDF element ID 106 of a PDF tag 104, is a paragraph. Responsive to determining that a PDF element ID 106 indicates a paragraph text element, the element manager 118 routes paragraph structure and content information 116 associated with the paragraph text element to the paragraph manager 122. In some embodiments, the paragraph structure information can include paragraphs identified as incomplete paragraphs using heuristics 112 and/or paragraphs identified as sharing one or more structural attributes. The paragraph content information can include the content of the tagged PDF incomplete paragraph element obtained from the PDF document 102.

In some embodiments, the element manager 118 is optionally included in the structural merger system 100. For example, in the absence of the element manager, the heading manager 120 and the paragraph manager 122 may receive all PDF tags 104 and ignore any tagged PDF element ID 106 that is not a heading or paragraph respectively. Alternatively, the heading manager 120 and the paragraph manager 122 may pull their desired inputs from an input storage location, such as a cache or other datastore.

At numeral 3, the heading manager 120 determines a likelihood of merging a candidate text heading with a target text heading using heading structure and content information 114. In some embodiments, the heading manager 120 selects one or more candidate text headings that are visually and contextually related to a target text heading. The likelihood of merging the candidate heading with the target heading is based on the font of the candidate heading and the font of the target heading (e.g., font information 108), the distance between the candidate heading and the target heading (e.g., boundary information 110), and the content of the candidate heading and the target heading. Accordingly, the heading manager 120 uses both structure data and context data to determine the likelihood of merging the candidate heading with the target heading. In operation, a language model 126 generates context data by generating a candidate heading embedding and a target heading embedding. A classifier 128 determines the likelihood of merging the candidate heading with the target heading using structural information such as font information 108 and boundary information 110, and the candidate heading embedding and target heading embedding received from the language model 126. In some embodiments, the classifier 128 classifies the candidate heading and the target heading with a merge classification (e.g., merge or do not merge).

At numeral 4, the paragraph manager 122 determines a likelihood of merging a candidate paragraph with a target paragraph using paragraph structure and content information 116. In some embodiments, the paragraph manager 122 selects a target paragraph that is incomplete using heuristics (e.g., PDF heuristics 112 associated with tagged PDF elements). The paragraph manager 122 then selects one or more candidate paragraphs that share similar structural attributes to the target incomplete paragraph and are also incomplete paragraphs. Accordingly, the paragraph manager 112 uses both structure data (e.g., incomplete paragraphs identified using PDF heuristics 112 and structural attributes of the incomplete paragraphs) and context data to identify and merge misidentified paragraph splits.

In operation, a language model 132 performs next sentence prediction using embeddings of candidate incomplete paragraphs and target incomplete paragraphs. The likelihood associated with the next sentence prediction task is the likelihood of merging the candidate incomplete paragraph and the target incomplete paragraph. Accordingly, the likelihood of merging the candidate paragraph with the target paragraph is based on the content of candidate paragraphs that have been identified as being incomplete paragraphs that share structural attributes and the content of the target paragraph. As described herein, in some embodiments, the language model 132 is the same as language model 126 because both the heading manager 120 and the paragraph manager 122 leverage embeddings associated with text elements to determine the likelihood of merging text elements.

At numeral 5, the merge manager 130 receives a likelihood of merging one or more candidate text elements with one or more target text elements from the heading manager 120 and/or the paragraph manager 122. For example, the heading manager 120 can pass a likelihood of merging a candidate heading with a target heading to merge manager 130. The paragraph manager 122 can pass a likelihood of merging a candidate incomplete paragraph with a target incomplete paragraph to merge manager 130.

As described herein, the likelihood of merging the first text element with the second text element (e.g., the candidate incomplete paragraph with the target incomplete paragraph and the candidate heading with the target heading) is based on the structure data and the context data associated with the first and second text elements. In some embodiments, the heading manager 120 and/or the paragraph manager 122 pass a merge classification associated with a pair of text elements. For example, the heading manager 120 can pass a merge classification (e.g., merge or do not merge) associated with a candidate heading and a target heading to the merge manager 130. Similarly, the paragraph manager 122 can pass a merge classification (e.g., merge or do not merge) associated with a candidate incomplete paragraph and a target incomplete paragraph to the merge manager 130.

Responsive to the merge likelihood satisfying one or more thresholds (or a particular merge classification such as “merge”), the merge manager 130 merges the candidate text element with the target text element. As a result, the merge manager 130 outputs merged PDF 124, as shown at numeral 6. In some embodiments, the merged PDF 124 is a PDF document with merged headings. The merged headings are headings that have been misidentified (e.g., based on the PDF tag 104) and should belong to a single heading.

In some embodiments, to merge the misidentified headings, the merge manager 130 updates the PDF tag 104 associated with the candidate heading and the target heading to indicate that the candidate heading and the target heading should be merged into a single heading. In other words, a tag associated with the target heading and/or candidate heading is updated. Additionally or alternatively, the PDF element ID 106 is updated to indicate that the candidate heading and the target heading headings should be merged into a single heading. For example, the PDF element ID of the candidate heading is updated to indicate that the candidate heading should be merged with the target heading. In other words, the PDF element ID 106 associated with the target heading and/or candidate heading is updated. In some embodiments, the merged PDF 124 merges the misidentified text elements. For example, the candidate heading and target heading are merged.

In some embodiments, the merged PDF 124 which is a PDF document with merged paragraphs. The merged paragraphs are paragraphs that have been misidentified (e.g., based on the PDF tag 104) and should belong to a single paragraph. In some embodiments, to merge the misidentified paragraphs, the merge manager 130 updates the PDF tag 104 associated with the candidate incomplete paragraph and the target incomplete paragraph to indicate that the candidate incomplete paragraph and the target incomplete paragraph should be merged into a single paragraph. In other words, a tag associated with the target incomplete paragraph and/or candidate incomplete paragraph is updated. Additionally or alternatively, the PDF element ID 106 is updated to indicate that the candidate incomplete paragraph and the target incomplete paragraph should be merged into a single paragraph. For example, the PDF element ID of the candidate paragraph is updated to indicate that the candidate paragraph should be merged with the target paragraph. In other words, the PDF element ID 106 associated with the target incomplete paragraph and/or candidate incomplete paragraph is updated. In some embodiments, the merged PDF 124 merges the misidentified text elements. For example, the candidate incomplete paragraph and target incomplete paragraph are merged.

The merged PDF 124 can be used for one or more downstream processes. For example, the merged PDF 124 can be used in an editing context. Specifically, one or more users can edit the merged PDF 124 by editing a paragraph PDF element merged using the paragraph PDF tags and/or editing a heading PDF element merged using the heading PDF tags. In some embodiments, the merged PDF 124 can be displayed or otherwise presented to a user. The merged PDF tags can make presentation of the merged PDF 124 appear contextually similar to the PDF document 102, irrespective of the computing device displaying the merged PDF 124. For example, one or more downstream processes like reflow, which is used to adjust the properties of merged PDF 124 to be displayed on various computing devices, can be used to display the merged PDF 124 to appear contextually similar to the PDF document 102. In operation, the merged PDF tags 104 (and/or PDF element ID 106 and/or PDF elements) maintain the informational flow of the PDF document 102.

In some embodiments, the structural merger system 100 executes one manager (e.g., the heading manager 120 or the paragraph manager 122). In other embodiments, the structural merger system 100 executes both the heading manager 120 and the paragraph manager 122 in parallel. In yet other embodiments, a first manager is executed (e.g., either the heading manager 120 or the paragraph manager 122) and subsequently a second manager is executed (e.g., either the paragraph manager 122 or the heading manager 120).

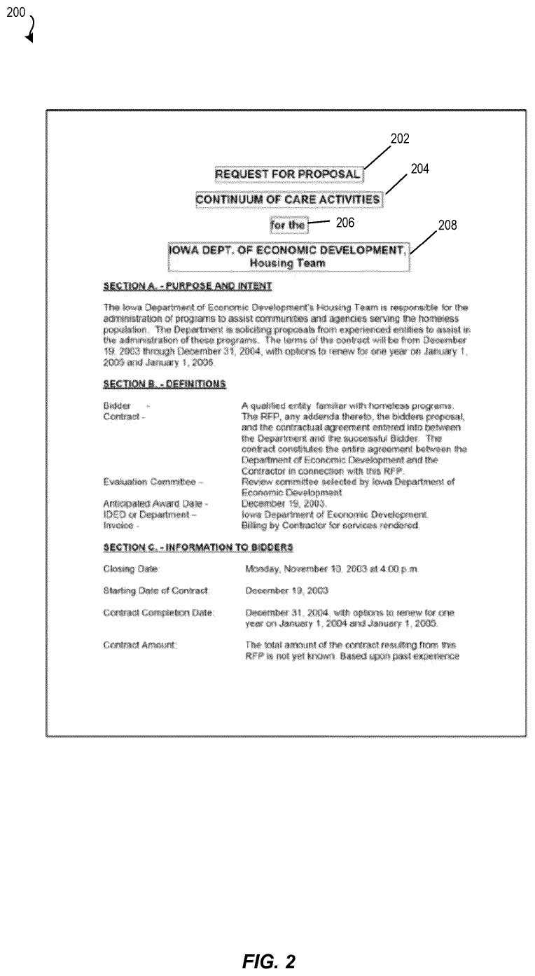

FIG. 2 illustrates an example PDF document with misidentified headings, in accordance with one or more embodiments. Example 200 illustrates a single page of a PDF. In example 200, each of the PDF tags of headings 202-208 are tagged as independent (illustrated by independent bounding boxes around each line of a heading). However, each of headings 202-208 are related such that each of headings 202-208 should be merged and identified as a single heading.

As described herein, the structural merger system 100 executes the heading manager 122 to identify candidate headings associated with each heading. For example, if the heading manager 122 selects heading 204 as the target heading, then the heading manager 122 may select adjacent headings such as heading 202 and heading 206. The heading manager 122 would then determine, based on the font similarity, distance, and context of the candidate headings (e.g., candidate heading 202 and candidate heading 206), that candidate heading 202 should be merged with target heading 204. For example, the PDF tag (e.g., the PDF element ID) associated with the candidate heading 202 and target heading 204 are updated.

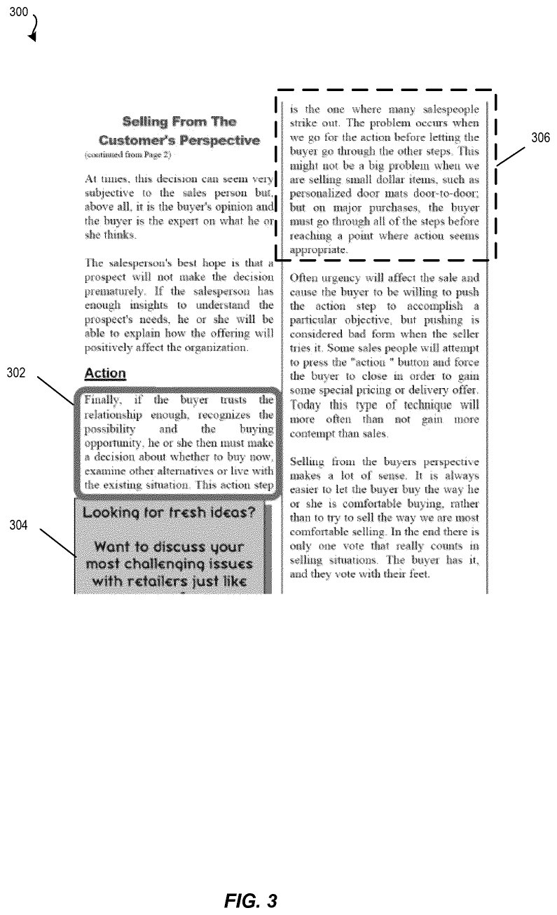

FIG. 3 illustrates an example PDF document with misidentified paragraphs, in accordance with one or more embodiments. Example 300 illustrates a single page of a PDF with two columns. In example 300, paragraph 302 is split by an artifact 304. As a result, the PDF tag of paragraph 302 received by the structural merger system 100 indicates that paragraph 302 is an independent paragraph. Similarly, the PDF tag of paragraph 306 received by the structural merger system 100 indicates that paragraph 306 is an independent paragraph. However, paragraph 302 is incomplete and is continued after the artifact, in the next column of the PDF document, at paragraph 306. Accordingly, both paragraph 302 and paragraph 306 have been misidentified. That is, paragraph 302 and paragraph 306 should be merged such that the PDF tag of paragraph 302, and the PDF tag of paragraph 306 indicate that paragraph 302 and paragraph 306 are incomplete portions of a single paragraph.

As described herein, the structural merger system 100 executes the paragraph manager 124 to identify the incomplete paragraphs 302 and 306. Subsequently, based on the structural information (both paragraphs being incomplete paragraphs with a shared structural attribute) and contextual information, the paragraph manager 124 would then determine that the two paragraphs 302 and 306 should be merged into a single paragraph. As described herein, in some embodiments, the tree representation of PDF tags would indicate that paragraph 302 and paragraph 306 are the same paragraph element such that the paragraphs 302 and 306 should be treated as a single paragraph.

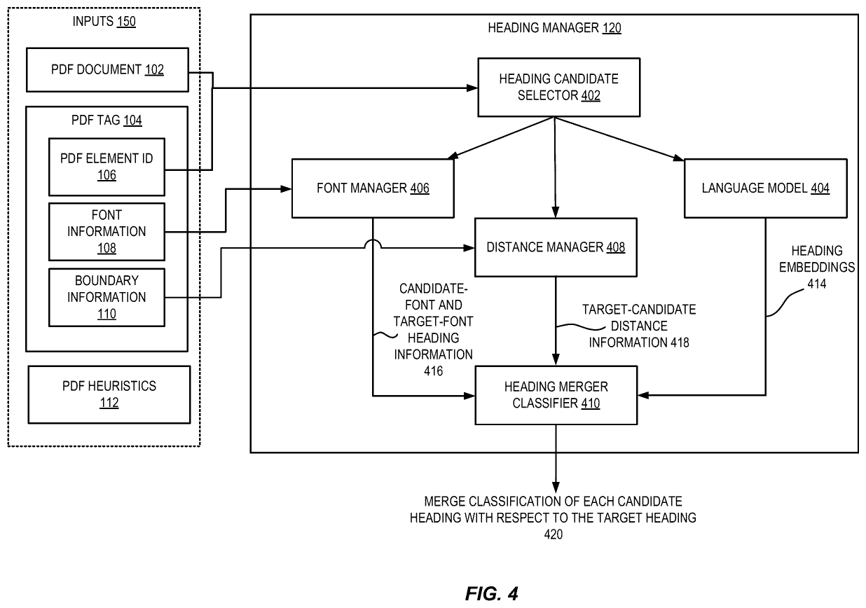

FIG. 4 illustrates a diagram of a process of merging headings using the heading manager, in accordance with one or more embodiments. The heading manager 120 determines whether headings tagged in the PDF tag 104 (e.g., via a “heading” PDF element ID 106) are split headings that should be merged into a single heading.

The heading candidate selector 402 selects a target heading from multiple text elements that are identified as headings via the PDF element ID 106. The target heading may be selected by the heading candidate selector 402 randomly, in an order (e.g., a first heading obtained by traversing the tree representation of PDF tags 104), and the like. Subsequently, the heading candidate selector 402 selects N candidate headings for the target heading based on structure information from the PDF document 102 (e.g., PDF element ID 106). In some embodiments, the heading candidate selector 402 selects candidate headings that are adjacent to the target heading. For example, the heading candidate selector 402 selects a candidate heading before the target heading (e.g., a PDF element ID of a heading in the tree representation of PDF tags that precedes the PDF element ID of the target heading) and a candidate heading after the target heading (e.g., a PDF element ID of a heading in the tree representation of PDF tags that succeeds the PDF element ID of the target heading). Accordingly, the heading candidate selector 402 selects N=2 candidate headings for a single target heading. In some embodiments, if the target heading is the first heading obtained by traversing the tree representation of PDF tags (e.g., there is no PDF element ID of a heading before the target heading), then the heading candidate selector 402 selects a single candidate heading after the target heading. Accordingly, the heading candidate selector 402 selects N=1 candidate headings for a single target heading. In some embodiments, any number of PDF elements IDs that are tagged as headings can be selected by the heading candidate selector 402 as a candidate. For example, the heading candidate selector 402 can select N candidate headings for N text elements that are tagged as headings (e.g., all of the text elements that are tagged as headings via the corresponding PDF element IDs are candidate headings).

A language model 404 determines heading embeddings 414 from N candidate headings and an associated target heading. The language model 404 encodes the headings to determine a heading embedding 414 for each of the candidate headings and the target embedding. An embedding is a numerical representation of a word (or phrase, sentence, paragraph) that encodes the meaning of the word. The language model 404 is any machine learning model trained to encode the headings to obtain a representation of the word that captures the content and/or context of the word. The heading embeddings 414 are passed to the heading merger classifier 410.

In some embodiments, the language model 404 is a bidirectional encoder representation for transformers (BERT) machine learning model. BERT is a machine learning model used to perform natural language processing (NLP) tasks. An off-the-shelf BERT is well suited for NLP tasks because BERT learns a contextual relationship of words (or characters, phrases) in one or more sentences.

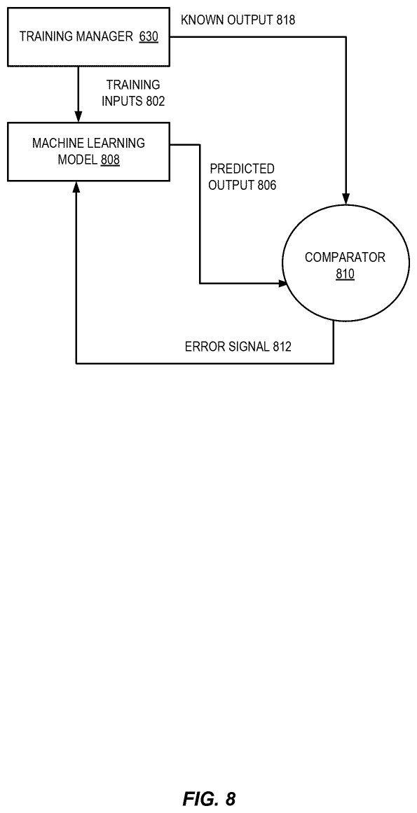

A neural network may include a machine-learning model that can be tuned (e.g., trained) based on training input to approximate unknown functions. In particular, a neural network can include a model of interconnected digital neurons that communicate and learn to approximate complex functions and generate outputs based on a plurality of inputs provided to the model. For instance, the neural network includes one or more machine learning algorithms. In other words, a neural network is an algorithm that implements deep learning techniques, i.e., machine learning that utilizes a set of algorithms to attempt to model high-level abstractions in data. Additional details with respect to the use of neural networks within the structural merger system 100 are discussed below with respect to FIG. 8.

The font manager 406 obtains font information 108 associated with the target heading and each of the candidate headings. As described herein, the font information 108 indicates a font style and/or a font weight of text elements. Using the target heading and candidate heading(s) received from the heading candidate selector 402 (e.g., identified using PDF element IDs 106, for instance), the font manager 406 can look up the font information 108 associated with target heading and candidate heading. For example, the font manager 406 uses the PDF tag 104 associated with the PDF element ID 106 of the target heading to determine font information 108 associated with the target heading. Similarly, the font manager 406 uses the PDF tag 104 associated with the PDF element ID 106 of the candidate heading to determine font information 108 associated with the candidate heading. Accordingly, the font manager 406 determines candidate-font and target-font heading information 416. The candidate-font and target-font heading information 416 are passed to the heading merger classifier 410.

The distance manager 408 obtains boundary information 110 for the target heading and each of the candidate headings. As described herein, the boundary information 110 can include bounding box information for each of the tagged elements in the PDF document 102. Using the target heading and candidate heading(s) received from the heading candidate selector 402 (e.g., identified using PDF element IDs 106, for instance), the distance manager 408 can look up boundary information 110 associated with the target heading and candidate heading. For example, the distance manager 408 uses the PDF tag 104 associated with the PDF element ID 106 of the target heading to determine boundary information 110 associated with the target heading. Similarly, the distance manager 408 uses the PDF tag 104 associated with the PDF element ID 106 of the candidate heading to determine boundary information 110 associated with the candidate heading. Then, the distance manager 408 determines the distance between the target heading and each of the candidate headings. For example, the distance manager 408 determines the distances between a center of the bounding box of the target heading and a center of the bounding box of each of the candidate headings. Accordingly, the distance manager 408 determines target-candidate distance information 418. The target-candidate distance information 418 is passed to the heading merger.

The heading merger classifier 410 is a machine learning model trained to determine whether a candidate heading should be merged with a target heading. For example, the heading merger classifier 410 is more likely to determine that the target should be merged with the candidate if the target heading and candidate heading have the same font. Similarly, the heading merger classifier 410 is more likely to determine that the target should be merged with the candidate if the distance between the bounding box of the candidate and the bounding box of the target are close.

In operation, the heading merger classifier 410 is a neural network that includes multiple layers (or sub-structures) of the neural network. Each layer includes a number of nodes that perform a particular computation. Nodes in each of the layers sum up values from adjacent nodes and apply an activation function, allowing the layers to detect nonlinear patterns of an input. Nodes are interconnected by weights, which are tuned during training. The adjustment of the weights through training facilitates the neural network's ability to predict a reliable and/or accurate output. Layers of the heading merger classifier 410 can include convolutional layers, pooling layers, encoding layers, decoding layers, attention layers, and the like. One of the layers of the heading merger can include a fully connected layer, which outputs a vector of real numbers. In some embodiments, a classifier such as the softmax function, is included as a layer of the heading merger classifier 410. The softmax function transforms an input of real numbers into a normalized probability distribution over predicted output classes. If there is one class, in some embodiments, a sigmoid function is used to classify the output. A softmax function is a multi-class sigmoid function.

The heading merger classifier 410 creates an input using a combination of the heading embeddings 414, the candidate-font and target-font heading information, 414 and target-candidate distance information 418. The heading merger classifier 410 then performs a binary classification of the heading embeddings in the input. For example, a first class is “merge” and a second class is “do not merge.” In other words, the heading merger classifier 410 determines a merge classification of each candidate heading with respect to the target heading 420. In operation, the heading merger classifier 410 predicts a likelihood of merging and performs the binary classification based on the likelihood of each embedding in the input satisfying one or more thresholds (e.g., a “merge” threshold or a “do not merge” threshold). Accordingly, responsive to the likelihood of one or more embeddings satisfying a threshold, the headings are classified as “merge” or “do not merge.”

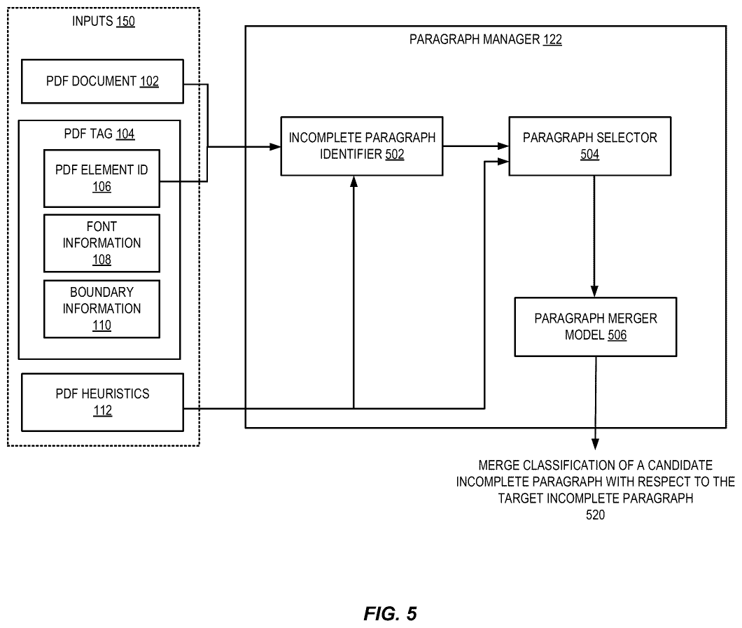

FIG. 5 illustrates a diagram of a process of merging paragraphs using the paragraph manager, in accordance with one or more embodiments. The paragraph manager 122 determines whether paragraphs tagged in the PDF tag 104 (e.g., via a “paragraph” PDF element ID 106) are split paragraphs that should be grouped into a single paragraph.

The incomplete paragraph identifier 502 identifies a set of incomplete paragraphs from the set of paragraphs in PDF document 102 using structural information of each paragraph text element. In operation, the incomplete paragraph identifier 502 obtains paragraph text elements (e.g., identified via PDF element ID 106) and determines whether each of the obtained paragraph is complete (or incomplete). For example, using heuristics 112, the incomplete paragraph identifier 502 can determine whether a PDF element identified as a paragraph includes a full stop. For example, the incomplete paragraph identifier 502 can use heuristics 112 to check for full stop terminations such as “.”, “!”, “?” at the end of a line. In operation, the incomplete paragraph identifier 502 scans a string to determine whether the string includes a full stop termination. If the paragraph includes a full stop, the incomplete paragraph identifier 502 can determine that the paragraph is a complete paragraph. In contrast, if the paragraph does not include a full stop, the incomplete paragraph identifier 502 determines that the paragraph is incomplete. The incomplete paragraph identifier 502 passes a set of incomplete paragraphs (and the set of corresponding PDF element IDs 106) to the paragraph selector 504 to filter the number of paragraphs received by the paragraph selector 504, reducing the number of candidate paragraphs that may be identified by the paragraph selector 504, as described below.

The paragraph selector 504 selects a target incomplete paragraph from the set of incomplete paragraphs received by the incomplete paragraph identifier 502. The paragraph selector 504 can select the target incomplete paragraph randomly, in an order (e.g., a first incomplete paragraph in the set of incomplete paragraphs obtained by traversing the tree representation of PDF tags 104), and the like. The paragraph selector 504 also selects candidate incomplete paragraphs as candidates to complete the target incomplete paragraph.

The paragraph selector 504 uses structural information to select candidate incomplete paragraphs from the set of incomplete paragraphs received from the incomplete paragraph identifier 502. In operation, the paragraph selector 504 selects candidate paragraphs from the set of incomplete paragraphs by identifying incomplete paragraphs of the set of incomplete paragraphs that are tagged with similar structural information as the structural information tagged in the target incomplete paragraph. For example, the paragraph selector 504 selects candidate incomplete paragraph from the set of incomplete paragraphs as incomplete paragraphs that share one or more structural attributes. In operation, the paragraph selector 504 matches structural information associated with the candidate incomplete paragraph with structural information associated with the target incomplete paragraph,

In some embodiments, the paragraph selector 504 uses structural information contained in the PDF element ID 106 to determine whether the structural information associated with the candidate incomplete paragraph matches structural information associated with the target incomplete paragraph (e.g., the candidate incomplete paragraph and the target incomplete paragraph share one or more structural attributes). For example, an artifact is a PDF element ID 106 (or an attribute of a PDF element ID) associated with a PDF element that identifies content that is not part of the primary content of the PDF document 102. For example, an artifact may include graphics separating sections of a document, headers or footers, and the like. To determine incomplete paragraphs that share structural attributes (e.g., “artifact” PDF elements), the paragraph selector 504 filters out all incomplete paragraphs received in the set of incomplete paragraphs that are not tagged as artifacts (e.g., via the PDF element ID 106). As another example, an aside is a PDF element ID 106 (or an attribute of a PDF element ID) associated with a PDF element that identifies content that is tangentially related to the primary content of the PDF document 102. For example, an aside may include decorative graphics, a text description of secondary (tangentially related) content, and the like. The paragraph selector 504 filters out all incomplete paragraphs received in the set of incomplete paragraphs that are not tagged as asides (e.g., via the PDF element ID 106).

In some embodiments, the paragraph selector 504 uses structural information identified using heuristics 112 to determine whether the structural information associated with the candidate incomplete paragraph matches the structural information associated with the target incomplete paragraph (e.g., the candidate incomplete paragraph and the target incomplete paragraph share one or more structural attributes). For example, the paragraph selector 504 selects candidate paragraphs from the set of incomplete paragraphs that are within the same page as the target incomplete paragraph. In general, the paragraph selector 504 selects paragraphs (e.g., candidate paragraphs and target paragraphs) from the same page. In some embodiments, the paragraph selector 504 selects paragraphs on different pages (e.g., candidate paragraphs and/or target paragraphs).

The paragraph selector 504 can determine whether to search for candidate incomplete paragraphs in other pages or not using the reading order of paragraphs of a page and the position of the target paragraph. For example, the paragraph selector 504 can evaluate whether a target incomplete paragraph is the last paragraph (e.g., based on the reading order of paragraphs). If the paragraph selector 504 determines that the target incomplete paragraph is the last paragraph, the paragraph selector 504 searches one or more adjacent pages for candidate incomplete paragraphs. If the paragraph selector 504 determines that the target incomplete paragraph is not a boundary paragraph (e.g., the last paragraph, based on the reading order) then the paragraph selector 504 searches for candidate incomplete paragraphs within the same page. In some embodiments, the reading order of paragraphs on a page is determined heuristically.

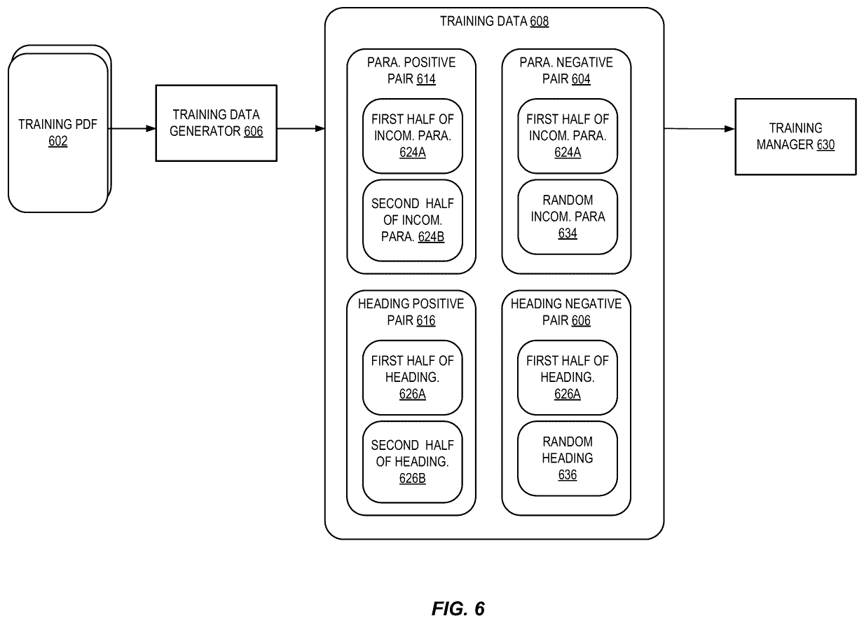

The paragraph merger model 506 is a machine learning model trained to determine whether a candidate incomplete paragraph should be merged with a target incomplete paragraph. In operation, the paragraph merger model 506 is a language model (in some embodiments, the same as language model 404 described in FIG. 4) that performs next sentence prediction to predict whether the candidate incomplete paragraph should be merged with the target incomplete paragraph. Next sentence prediction is a task that evaluates whether adjacent sentences (or tokens, paragraphs, and the like) are related. As described with reference to FIGS. 6 and 8, the paragraph merger model 506 (e.g., a language model) learns to predict whether paragraphs are related by learning features of similar and dissimilar paragraphs. The output of the paragraph merger model 506 is a next sentence prediction (or next paragraph prediction) classification (or score) of whether a candidate incomplete paragraph should be merged with a target incomplete paragraph. The next sentence prediction classification (or score) indicates whether the target incomplete paragraph should follow the candidate incomplete paragraph (or vice-versa). Accordingly, the next sentence prediction score is mapped to the likelihood of merging the candidate incomplete paragraph with the target incomplete paragraph. As a result, the output of paragraph merger model 506 is a merge classification of a candidate incomplete paragraph with respect to the target incomplete paragraph 520 based on a likelihood of merging the candidate incomplete paragraph with the target incomplete paragraph (e.g., the next sentence prediction score) satisfying a threshold.

FIG. 6 illustrates obtaining training data used to train a language model, in accordance with one or more embodiments. As shown, a training data generator 606 generates training data 608 from a training PDF 602. Training data 608 includes paragraph positive pair 614 (e.g., a first half of an incomplete paragraph 624A and the remaining half of the incomplete paragraph 624B), paragraph negative pair 604 (e.g., a first half of the incomplete paragraph 624A and a randomly sampled incomplete paragraph 634), heading positive pair 616 (e.g., a first half of a heading 626A and the second half of the heading 626B), and heading negative pair 606 (e.g., a first half of the heading 626 and a randomly sampled heading 636). It should be appreciated that the training data generator 606 can determine training data 608 from other documents (e.g., text documents) and other text granularities (e.g., sentence positive/negative pairs).

The training PDF 602 is any digital file including at least one or more text paragraphs and/or one or more headings and corresponding PDF tags for the one or more text paragraphs and/or one or more headings. The training data generator 606 can obtain the training PDF 602 from one or more data stores. Additionally or alternatively, training PDF 602 may be uploaded to the training data generator 606.

The training data generator 606 generates paragraph positive pairs 614 by splitting paragraphs of the training PDF 602. Because the training PDF 602 includes PDF tags of elements in the training PDF 602 (e.g., PDF tags of paragraphs and PDF tags of headings), the training data generator 606 can identify paragraphs included in the training PDF 602. The training data generator 606 randomly selects a paragraph in the training PDF 602 and splits the selected paragraph based on, for example, punctuation splitting, hyphen splitting, or space-based splitting. For example, for punctuation splitting, the training data generator 606 identifies a kth punctuation (e.g., a k number of periods, a k number of commas, etc.) in the selected paragraph and splits the selected paragraph at the k^{th} punctuation. In some embodiments, k is a randomly sampled constrained integer (e.g., between 1 and 4). In other embodiments, k is predetermined. For example, the training data generator 606 splits a paragraph after the second period (e.g., at the start of the third sentence). Similarly, for space-based splitting, the training data generator 606 identifies m number of spaces and splits the selected paragraph at the m^{th} space. The value of m can be a randomly sampled in a constrained set of integers, predetermined, or equal to the value of k. The first part of the split paragraph (e.g., before the k^{th} punction or m^{th} space) is the first half of the incomplete paragraph 624A of the paragraph positive pair 614. The second part of the split paragraph (e.g., after the k^{th} punction or m^{th} space) is the second half of the incomplete paragraph 624B of the paragraph positive pair 614.

The training data generator 606 can determine paragraph negative pairs 604 by pairing the first half of the incomplete paragraph 624A (or the second half of the incomplete paragraph 624B) with other split paragraphs in the training PDF 602. In operation, the training data generator 606 determines paragraph negative pairs 604 by pairing the portions (e.g., halves) of the different paragraphs. For example, the training data generator 606 can split a first paragraph of the training PDF 602 into a first portion of the first paragraph and a second portion of the first paragraph. The training data generator 606 can also split a second paragraph of the training PDF 602 into a first portion of the second paragraph and a second portion of the second paragraph. The first paragraph and the second paragraph may be split the same way (e.g., space-based splitting) or different ways (e.g., the first paragraph is split using space-based splitting and the second paragraph is split using punction-based splitting). A paragraph negative pair, determined by the training data generator 606, can be the first portion of the first paragraph paired with the first portion of the second paragraph, the first portion of the first paragraph paired with the second portion of the second paragraph, the second portion of the first paragraph paired with the second portion of the second paragraph, or the second portion of the first paragraph paired with the first portion of the second paragraph.

The training data generator 606 also generates heading positive pairs 616 by splitting headings of the training PDF 602. Because the training PDF 602 includes PDF tags for elements of the training PDF 602 (e.g., PDF tags of paragraphs and PDF tags of headings), the training data generator 606 can identify headings included in the training PDF 602. In operation, the training data generator 606 identifies multiline headings using the PDF tags of headings in the training PDF 602. The training data generator 606 splits a multiline heading into multiple single line headings. For example, a multiline heading includes a ‘/n’ character, indicating that the text of the heading is spread over multiple lines. In some embodiments, the training data generator 606 splits a line of a multiline heading responsive to identifying a ‘/n’ character in a string of text associated with the heading. Headings on adjacent lines of the split multiline heading are determined, by the training data generator 606, to be positive pairs, and headings on lines of different split multiline headings are determined to be negative pairs.

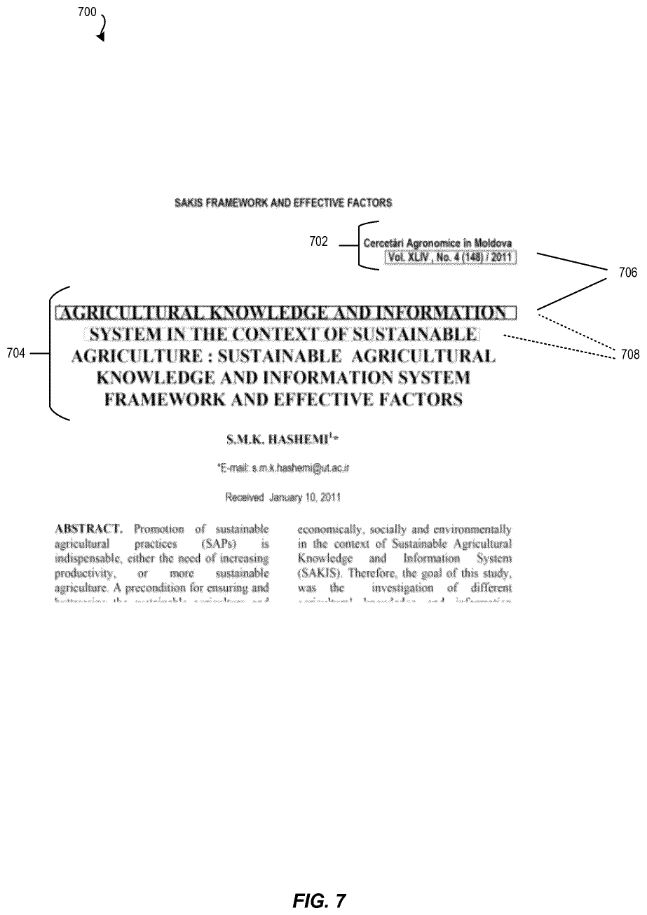

FIG. 7 illustrates positive heading pairs and negative heading pairs, in accordance with one or more embodiments. The training PDF 700 includes a first multiline header 702 (e.g., two lines) and a second multiline header 704 (e.g., five lines). As described herein, the training data generator 606 of FIG. 6 splits multiline headings into single lines. Accordingly, the first multiline header 702 is split into two single line headers, and the second multiline header 704 is split into five single line headers. The training data generator 606 determines that headings on adjacent lines of the split multiline heading are positive pairs. For example, the first and second lines of the multiline heading 704 can become positive pair 708. In contrast, headings on different lines of split multiline headings are negative pairs. For example, the second line of the first multiline heading 702 can be paired with the first line of the second multiline heading 704, as shown by negative pair 706.

FIG. 8 illustrates an example process of supervised learning used to train a machine learning model, in accordance with one or more embodiments. Supervised learning is a method of training a machine learning model given input-output pairs. An input-output pair is an input with an associated known output (e.g., an expected output, a labeled output, a ground truth). The machine learning model 808 is trained on known input-output pairs such that the machine learning model 808 can learn how to predict known outputs given known inputs.

The machine learning model 808 can represent the heading merger classifier 410 described in FIG. 4, the language model 404 described in FIG. 4, and/or the paragraph merger model 506 described in FIG. 5. That is, each of the heading merger classifier 410, the language model 404, and/or the paragraph merger model 506 can be trained using supervised learning. It should be appreciated that while supervised learning is described, other training methods can be used by the training manager 630 to train the machine learning model 830.

As described herein, the paragraph merger (e.g., paragraph merger model 506 described in FIG. 5) may be a language model. In some embodiments, the paragraph merger model 506 is the same as language model 404. In some embodiments, the language model (e.g., paragraph merger model 506 and/or language model 404) is a pretrained BERT model. As described below, when BERT is used to perform next sentence prediction, BERT can include at least two stages of operations. In a first stage, BERT generates embeddings and in a second stage, BERT attends to each of the embeddings. In embodiments where the paragraph merger model 506 described in FIG. 5 and the language model 404 described in FIG. 4 are the same BERT model, then the language model 404 outputs the embeddings determined during the first stage of operations and the paragraph merger model 506 outputs the next sentence prediction classification determined during the second stage of operations.

Next sentence prediction is a task that involves evaluating whether pairs of sentences are related (e.g., whether a second sentence comes after a first sentence). In operation, the BERT model receives sentences and tokenizes the words of each sentence. For example, each word of the sentence is partitioned into a unit (e.g., a token). During the first stage of operations, BERT transforms each token into a token embedding, which is a latent space representation of the token. The embedding encodes the meaning of the token in an embedding space, where tokens associated with words having similar meanings are positioned closer together in the embedding space. During the second stage of operations, one of more layers of BERT (where a layer, as described herein is a sub-structure of a machine learning model), perform attention on the token embeddings, which weighs each token based on a task (e.g., next sentence prediction) and the token's relevance to the task. Because each token is weighted with respect to other tokens in the sentence, BERT is able to capture longer-term dependencies across words in a sentence. One or more other layers of BERT can perform classification of a vector of real numbers using a softmax function, as described herein. For example, the softmax function is used to classify whether the received sentences are “next sentence” or “not next sentence.”

While a pretrained machine learning model (such as BERT) may be well suited to perform various domain-neutral tasks (e.g., tasks learned using widely available or public data), applying domain-specific data to such trained machine learning models can cause a drop in the machine learning model's next sentence prediction performance. For example, a machine learning model is less suited to perform next sentence prediction of a domain-specific text if the machine learning model has not been trained to perform next sentence prediction using domain-specific language.

Fine-tuning a pre-trained machine learning model as used herein may refer to a mechanism of adjusting the hyperparameters of the machine learning model that has been pre-trained on domain-neutral data, and then tuning the pre-trained machine learning model to perform a similar task in a domain-specific environment. Accordingly, the training manager 630 fine-tunes the machine learning model 808 (e.g., the language model 404 described in FIG. 4 and/or the paragraph merger model 506 described in FIG. 5) using domain-specific data (e.g., training data 608 generated by the training data generator 606, described in FIG. 6).

As described herein, the language model 404 is used by the heading manager 120 (described in FIG. 4) and the paragraph merger model 506 is used by the paragraph manager 122 (described in FIG. 5). Accordingly, the training manager 630 trains (or fine-tunes) the language model 404 (e.g., as the machine learning model 808) using heading training data (e.g., heading positive pairs 616 and heading negative pairs 606 described in FIG. 6). For example, if the machine learning model 808 is the language model 404, the training inputs 802 can be a positive pair of headings or a negative pair of headings (e.g., heading positive pair 616 including a first half of heading 626A and a second half of heading 626B or a heading negative pair 606 including a first half of heading 626A and a random heading 636). The corresponding known output 818 is a label indicating whether the pair of headings is a positive or negative pair. Determining whether the pair of training inputs 802 is positive or negative teaches the machine learning model 808 to classify whether to merge headings because positive pairs of headings indicate that the training inputs 802 should be merged, while negative pairs of headings indicate that training inputs 802 should not be merged.

In some embodiments, the training manager 630 trains the language model 404 (e.g., the paragraph merger model 506 described in FIG. 5) as the machine learning model 808 using paragraph training data (e.g., paragraph positive pairs 614 and paragraph negative pairs 604 described in FIG. 6). If the machine learning model 808 is the paragraph merger model 506, the training inputs 802 can be a positive pair of paragraphs or a negative pair of paragraphs (e.g., paragraph positive pair 614 including a first half of incomplete paragraph 624A and a second half of incomplete paragraph 624B or a paragraph negative pair 604 including a first half of incomplete paragraph 624A and a random incomplete paragraph 634). The corresponding known output 818 is a label indicating whether the pair of headings is a positive or negative pair. Determining whether the pair of training inputs 802 is positive or negative teaches the machine learning model 808 to classify whether to merge paragraphs because positive pairs of paragraphs indicate that the training inputs 802 should be merged, while negative pairs of paragraphs indicate that the training inputs 802 should not be merged.

In some embodiments, the machine learning model 808 (e.g., the language model 404 and/or the paragraph merger model 506) can be trained using both heading training data and paragraph training data (e.g., heading positive pairs 616, heading negative pairs 606, paragraph positive pairs 614, and paragraph negative pairs 604 described in FIG. 6)

If the machine leaning model 808 is the heading merger classifier 410, the training input 802 can include candidate-font and target-font heading information (e.g., such as the candidate-font and target-font heading information 416 of FIG. 4), target-candidate distance information (such as the target-candidate distance information 418 of FIG. 4), and heading embeddings (such as heading embeddings 414 of FIG. 4). The corresponding known output 818 is a “merge” or “not merge” classification. In some embodiments, the corresponding known output 818 is based on the target heading and one or more candidate headings that are transformed into embeddings by the language model 404, as described herein with reference to FIG. 4. For example, if the language model 404 receives a positive pair of headings and determines embeddings (e.g., embeddings 414) using the positive pair of headings, the corresponding known output 818 used to train the heading merger classifier 410 is “merge” because the headings are a positive pair. Similarly, if the language model 404 receives a negative pair of headings and determines embeddings (e.g., embeddings 414) using the negative pair of heading, the corresponding known output 818 used to train the heading merger classifier 410 is “not merge” because the headings are a negative pair.

The machine learning model 808 uses the training inputs 802 to predict an output 806 by applying the current state of the machine learning model 808 to the training inputs 802. The comparator 810 compares the predicted output 806 to the known output 818 to determine an amount of error or differences.

The error (represented by error signal 812) determined by the comparator 810 may be used to adjust the weights in the machine learning model 808 such that machine learning model 808 changes (or learns) over time to generate a relatively accurate predicted output 806 using the input-output pairs. The machine learning model 808 may be trained using the backpropagation algorithm, for instance. The backpropagation algorithm operates by propagating the error signal 812. The error signal 812 may be calculated each iteration (e.g., each pair of training inputs 802 and associated known outputs 818), batch, and/or epoch and propagated through all of the algorithmic weights in the machine learning model 808 such that the algorithmic weights adapt based on the amount of error. The error is minimized using a loss function. Non-limiting examples of loss functions may include the square error function, the room mean square error function, and/or the cross-entropy error function.

The weighting coefficients of the machine learning model 808 may be tuned to reduce the amount of error thereby minimizing the differences between (or otherwise converging) the predicted output 806 and the known output 818. The machine learning model 808 may be trained until the error determined at the comparator 810 is within a certain threshold (or a threshold number of batches, epochs, or iterations have been reached).

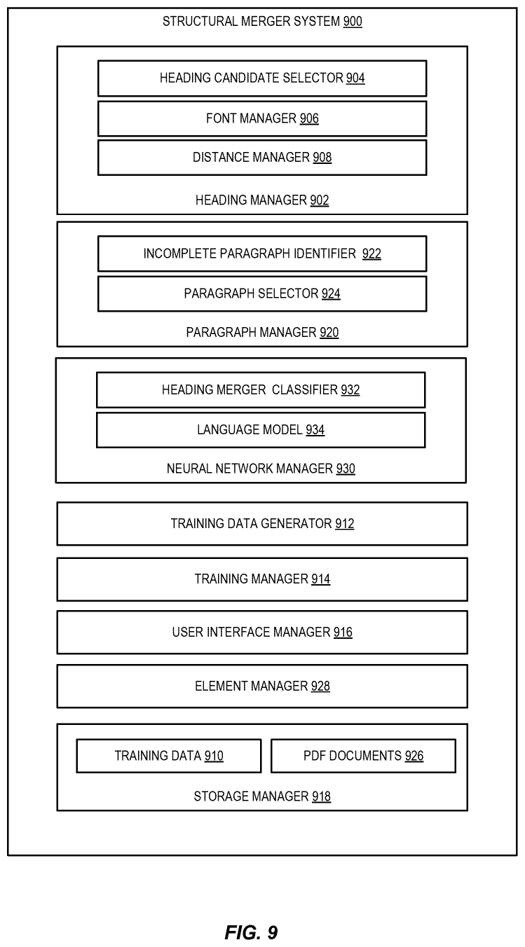

FIG. 9 illustrates a schematic diagram of structural merger system (e.g., “structural merger system” described above) in accordance with one or more embodiments. As shown, the structural merger system 900 may include, but is not limited to, a heading manager 902, a paragraph manager 920, a neural network manager 930, a training data generator 912, a training manager 914, a user interface manager 916, and a storage manager 918. The heading manager 902 includes a heading candidate selector 904, a font manager 906, and a distance manager 908. The paragraph manager 920 includes an incomplete paragraph identifier 922 and a paragraph selector 924. The neural network manager 930 includes a heading merger classifier 932 and a paragraph merger 924. The data store 918 includes training data 910 and PDF documents 926.

As illustrated in FIG. 9, the structural merger system 900 includes a heading manager 902. The heading manager 902 determines a likelihood of merging a candidate text heading with a target text heading. The heading manager 902 selects one or more candidate text headings that are visually and contextually related to a target text heading. Accordingly, the heading manager 902 uses both structure data and context data to determine the likelihood of merging the candidate text heading with the target text heading. In operation, the likelihood of merging the candidate heading with the target text heading is based on the font of the candidate text heading and the font of the target text heading, the distance between the candidate text heading and the target text heading, and the content of the candidate text heading and the target text heading.

The heading manager 902 includes a heading candidate selector 904. The heading candidate selector 904 first selects a target heading from multiple text elements that are identified as headings (e.g., via PDF tags). The target heading may be selected by the heading candidate selector 904 randomly, in an order (e.g., a first heading obtained by traversing the tree representation of PDF tags), and the like. Subsequently, the heading candidate selector 904 selects N candidate headings for the target heading. In some embodiments, the selected candidate headings are the one or more headings adjacent to the target heading. For example, the heading candidate selector 904 selects a candidate heading before the target heading (e.g., a PDF tag in the tree representation of PDF tags that precedes the target heading) and a candidate heading after the target heading (e.g., a PDF tag in the tree representation of PDF tags that succeeds the target heading).

The heading manager 902 also includes a font manager 906. The font manager 906 obtains font information associated with the target heading and each of the candidate headings. As described herein, the font information indicates a font style and/or a font weight of text elements. Using the target heading and candidate heading(s) received from the heading candidate selector 904 (identified using PDF element IDs, for instance), the font manager 906 can look up the font information associated with target heading and candidate heading.

The heading manager 902 also includes a distance manager 908. The distance manager 908 obtains boundary information for the target heading and each of the candidate headings. As described herein, the boundary information can include bounding box information for each of the tagged elements in the document. Using the target heading and candidate heading(s) received from the heading candidate selector 904 (identified using PDF element IDs, for instance), the distance manager 908 can look up boundary information associated with the target heading and candidate heading.

As illustrated in FIG. 9, the structural merger system 900 includes a paragraph manager 920. The paragraph manager 920 determines a likelihood of merging a candidate incomplete paragraph with a target incomplete paragraph. The paragraph manager 920 selects one or more candidate incomplete paragraphs that share structural similarities with a target incomplete paragraph. Accordingly, the paragraph manager 920 uses both structure data (e.g., incomplete paragraphs identified using PDF heuristics and structural attributes of the incomplete paragraphs) and context data to identify and merge misidentified paragraph splits. In operation, the likelihood of merging the candidate paragraph with the target paragraph is based on the content of candidate paragraphs that have been identified as being incomplete paragraphs that share structural attributes and the content of the target paragraph.

The paragraph manager 920 includes an incomplete paragraph identifier 922. The incomplete paragraph identifier 922 uses structural information of each paragraph text element to filter the number of paragraphs that may be selected as candidate paragraphs, determined by the paragraph selector 924. In operation, the incomplete paragraph identifier 922 determines a set of incomplete paragraphs by determining whether each of the paragraph identified via PDF elements is complete (or incomplete). For example, using heuristics, the incomplete paragraph identifier 922 can determine whether a PDF element identified as a paragraph includes a full stop.

The paragraph manager 920 also includes a paragraph selector 924. The paragraph selector 924 selects a target incomplete paragraph from the set of incomplete paragraphs. The paragraph selector 924 can select the target incomplete paragraph randomly, in an order (e.g., a first incomplete paragraph in the set of incomplete paragraphs obtained by traversing the tree representation of PDF tags), and the like. The paragraph selector 924 also selects candidate incomplete paragraphs from the set of incomplete paragraphs as candidates to complete the target incomplete paragraph using structural information. In operation, the paragraph selector 924 selects candidate paragraphs from the set of incomplete paragraphs by identifying incomplete paragraphs of the set of incomplete paragraphs that are tagged with similar structural information as the structural information tagged in the target incomplete paragraph. For example, the paragraph selector 924 selects candidate incomplete paragraph from the set of incomplete paragraphs as incomplete paragraphs that share one or more structural attributes. The paragraph selector 924 uses structural information implicit in PDF tags and/or structural information identified using heuristics to identify incomplete paragraphs that share one or more structural attributes.

As illustrated in FIG. 9, the structural merger system 900 also includes a neural network manager 930. Neural network manager 930 may host a plurality of neural networks or other machine learning models, such as heading merger classifier 932 and/or language model 934. The neural network manager 930 may include an execution environment, libraries, and/or any other data needed to execute the machine learning models. In some embodiments, the neural network manager 930 may be associated with dedicated software and/or hardware resources to execute the machine learning models.

As discussed, heading merger classifier 932 is a machine learning model trained to determine whether a candidate heading should be merged with a target heading. For example, the heading merger classifier 932 is more likely to determine that the target should be merged with the candidate if the target heading and candidate heading have the same font. Similarly, the heading merger classifier 932 is more likely to determine that the target should be merged with the candidate if the distance between the bounding box of the candidate and the bounding box of the target are close. In some embodiments, the heading merger classifier 932 is a five layer neural network that performs a binary classification of an input (e.g., the heading embeddings, the candidate-font and target-font heading information, and target-candidate distance information).

Further, language model 934 is a machine learning model trained to perform next sentence prediction to determine whether candidate text elements and target text elements should be merged, based on a similarity of embeddings. In some embodiments, the language model 934 determines embeddings of text elements. For example, the embeddings may be heading embeddings determined from candidate headings and a target heading. As described herein, the heading embeddings can be passed to the heading merger classifier 932 to be classified. The embeddings may also be incomplete paragraph embeddings determined from candidate incomplete paragraphs and a target incomplete paragraph. The incomplete paragraph embeddings can be used to determine a merge classification by the language model 934 performing the next sentence prediction task. In other words, the likelihood of the next sentence prediction corresponds to the likelihood of merging the incomplete paragraphs.

Although depicted in FIG. 9 as being hosted by a single neural network manager 930, in various embodiments the neural networks may be hosted in multiple neural network managers and/or as part of different components. For example, the heading merger classifier 932 and language model 934 can each be hosted by their own neural network manager, or other host environment, in which the respective neural networks execute, or the neural networks may be spread across multiple neural network managers depending on, e.g., the resource requirements of the heading merger classifier 932 and/or language model 934.

As illustrated in FIG. 9, the structural merger system 900 also includes a training data generator 912. The training data generator 912 generates training data 910 including paragraph positive pairs, paragraph negative pairs, heading positive pairs, and heading negative pairs. The training data generator 912 generates paragraph positive pairs by splitting paragraphs of the training PDF. The training data generator 912 randomly selects a paragraph in the training PDF and splits the selected paragraph based on, for example, punctuation splitting, hyphen splitting, or space-based splitting. The training data generator 912 can determine paragraph negative pairs by pairing the first half of the incomplete paragraph (or the second half of the incomplete paragraph) with other split paragraphs in the training PDF. In operation, the training data generator 912 determines paragraph negative pairs by pairing the portions (e.g., halves) of the different paragraphs. The training data generator 912 also generates heading positive pairs by splitting headings of the training PDF. In operation, the training data generator 912 identifies multiline headings using the PDF tags of headings in the training PDF. The training data generator 912 splits a multiline heading into multiple single line headings. Headings on adjacent lines of the split multiline heading are determined, by the training data generator 912, to be positive pairs, and headings on lines of different split multiline headings are determined to be negative pairs.

As illustrated in FIG. 9 the structural merger system 900 also includes training manager 914. The training manager 914 can teach, guide, tune, and/or train one or more neural networks. In particular, the training manager 914 can train a neural network based on the training data generated by the training data generator 912.

Fine-tuning a pre-trained machine learning model as used herein may refer to a mechanism of adjusting the hyperparameters of the machine learning model that has been pre-trained on domain-neutral data, and then tuning the pre-trained machine learning model to perform a similar task in a domain-specific environment. Accordingly, the training manager 914 fine-tunes the language model 934 and the heading merger classifier 932 using domain-specific data (e.g., training data 910 generated by the training data generator 912). The domain-specific training data 910 includes paragraph positive pairs, paragraph negative pairs, heading positive pairs, and heading negative pairs. The training manager 914 fine-tunes the language model 934 using domain-specific training data 910 to determine text embeddings and subsequently uses the determined text embeddings to perform a next sentence prediction task. The likelihood of the next sentence prediction is used as a merge classification. The training manager 914 fine-tunes the heading merger classifier 932 to determine a merge classification using domain-specific training data 910.

As illustrated in FIG. 9 the structural merger system 900 includes a user interface manager 916. For example, the user interface manager 916 allows users to provide PDF documents 926 to the structural merger system 900. In some embodiments, the user interface manager 916 provides a user interface through which the user can upload the PDF documents 926 which represent a PDF document to be evaluated for misidentified text structures, as discussed above. Alternatively, or additionally, the user interface 916 may enable the user to download the PDF documents 926. For example, after the structural merger system 900 has merged any misidentified headings or paragraphs of the PDF document 926. Additionally, the user interface manager 916 allows users to request the structural merger system 900 be run on a PDF document 926.

As illustrated in FIG. 9, the structural merger system 900 includes an element manager 928. As described above, in some embodiments, the element manager 928 is optionally included in the structural merger system 900. The element manager 928 routes text elements to corresponding managers of the structural merger system 900. In operation, the element manager 928 determines whether a text element, identified via a PDF element ID of a PDF tag, is a heading. Responsive to determining that a PDF element ID indicates a heading text element, the element manager 928 routes heading structure and content information to the heading manager 902. Similarly, the element manager 928 determines whether a text element, identified via a PDF element ID of a PDF tag, is a paragraph. Responsive to determining that a PDF element ID indicates a paragraph text element, the element manager 928 routes paragraph structure and content information to the paragraph manager 920.

As illustrated in FIG. 9, the structural merger system 900 also includes the storage manager 918. The storage manager 918 maintains data for the structural merger system 900. The storage manager 918 can maintain data of any type, size, or kind as necessary to perform the functions of the structural merger system 900. The storage manager 918, as shown in FIG. 9, includes training data 910 and PDF documents 926. The training data 910 is data determined by the training data generator 912 including positive heading pairs, negative heading pairs, positive paragraph pairs, and negative paragraph pairs. The PDF documents 926 are documents received by the structural merger system 900.

Each of the components of the structural merger system 900 and their corresponding elements (as shown in FIG. 9) may be in communication with one another using any suitable communication technologies. It will be recognized that although components and their corresponding elements are shown to be separate in FIG. 9, any of components and their corresponding elements may be combined into fewer components, such as into a single facility or module, divided into more components, or configured into different components as may serve a particular embodiment.

The components and their corresponding elements can comprise software, hardware, or both. For example, the components and their corresponding elements can comprise one or more instructions stored on a computer-readable storage medium and executable by processors of one or more computing devices. When executed by the one or more processors, the computer-executable instructions of the structural merger system 900 can cause a client device and/or a server device to perform the methods described herein. Alternatively, the components and their corresponding elements can comprise hardware, such as a special purpose processing device to perform a certain function or group of functions. Additionally, the components and their corresponding elements can comprise a combination of computer-executable instructions and hardware.

Furthermore, the components of the structural merger system 900 may, for example, be implemented as one or more stand-alone applications, as one or more modules of an application, as one or more plug-ins, as one or more library functions or functions that may be called by other applications, and/or as a cloud-computing model. Thus, the components of the structural merger system 900 may be implemented as a stand-alone application, such as a desktop or mobile application. Furthermore, the components of the structural merger system 900 may be implemented as one or more web-based applications hosted on a remote server. Alternatively, or additionally, the components of the structural merger system 900 may be implemented in a suite of mobile device applications or “apps.”

As shown, the structural merger system 900 can be implemented as a single system. In other embodiments, the structural merger system 900 can be implemented in whole, or in part, across multiple systems. For example, one or more functions of the structural merger system 900 can be performed by one or more servers, and one or more functions of the structural merger system 900 can be performed by one or more client devices. The one or more servers and/or one or more client devices may generate, store, receive, and transmit any type of data used by the structural merger system 900, as described herein.

In one implementation, the one or more client devices can include or implement at least a portion of the structural merger system 900. In other implementations, the one or more servers can include or implement at least a portion of the structural merger system 900. For instance, the structural merger system 900 can include an application running on the one or more servers or a portion of the structural merger system 900 can be downloaded from the one or more servers. Additionally or alternatively, the structural merger system 900 can include a web hosting application that allows the client device(s) to interact with content hosted at the one or more server(s).

For example, upon a client device accessing a webpage or other web application hosted at the one or more servers, in one or more embodiments, the one or more servers can provide access to a document stored at the one or more servers. Upon receiving the document, the one or more servers can automatically perform the methods and processes described above to merge misidentified text splits by determining whether one or more text elements (e.g., headings or paragraphs) should be merged. The one or more servers can an updated document including merged text elements to the client device for display to the user.

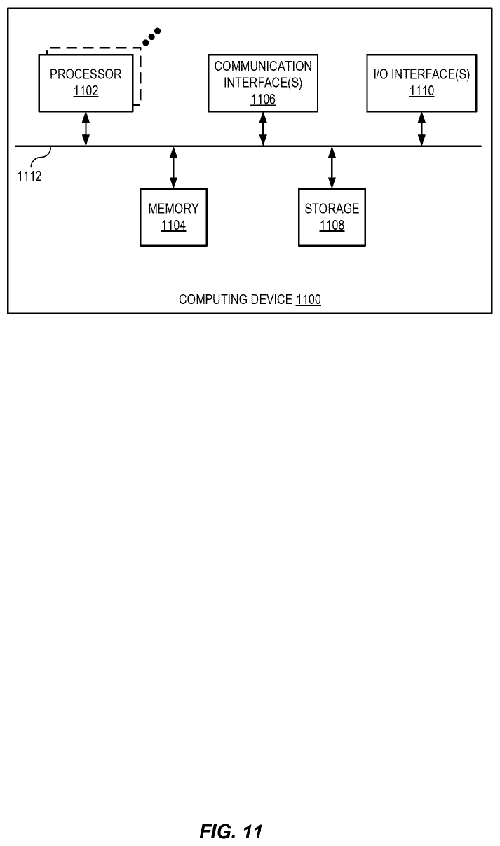

The server(s) and/or client device(s) may communicate using any communication platforms and technologies suitable for transporting data and/or communication signals, including any known communication technologies, devices, media, and protocols supportive of remote data communications, examples of which will be described in more detail below with respect to FIG. 11. In some embodiments, the server(s) and/or client device(s) communicate via one or more networks. A network may include a single network or a collection of networks (such as the Internet, a corporate intranet, a virtual private network (VPN), a local area network (LAN), a wireless local network (WLAN), a cellular network, a wide area network (WAN), a metropolitan area network (MAN), or a combination of two or more such networks. The one or more networks will be discussed in more detail below with regard to FIG. 11.

The server(s) may include one or more hardware servers (e.g., hosts), each with its own computing resources (e.g., processors, memory, disk space, networking bandwidth, etc.) which may be securely divided between multiple customers (e.g. client devices), each of which may host their own applications on the server(s). The client device(s) may include one or more personal computers, laptop computers, mobile devices, mobile phones, tablets, special purpose computers, TVs, or other computing devices, including computing devices described below with regard to FIG. 11.

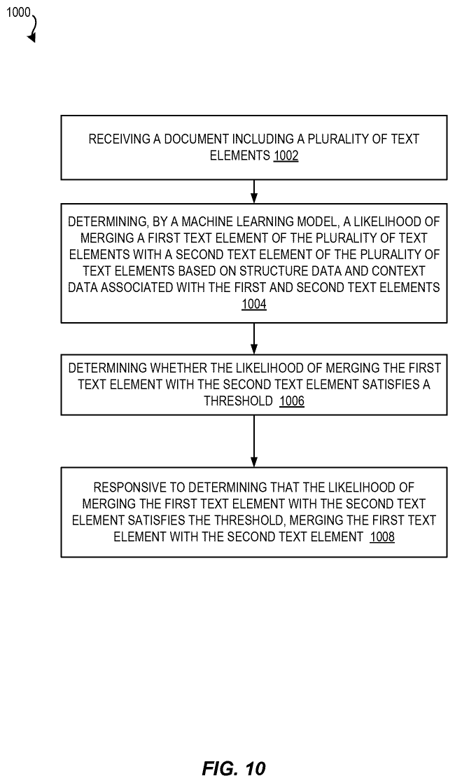

FIGS. 1-9, the corresponding text, and the examples, provide a number of different systems and devices that allows a user to receive coherent documents, where a coherent document is a document with merged paragraphs and headings. In addition to the foregoing, embodiments can also be described in terms of flowcharts comprising acts and steps in a method for accomplishing a particular result. For example, FIG. 10 illustrates a flowchart of an exemplary method in accordance with one or more embodiments. The method described in relation to FIG. 10 may be performed with fewer or more steps/acts or the steps/acts may be performed in differing orders. Additionally, the steps/acts described herein may be repeated or performed in parallel with one another or in parallel with different instances of the same or similar steps/acts.

FIG. 10 illustrates a flowchart 1000 of a series of acts in a method of merging misidentified text structures in accordance with one or more embodiments. In one or more embodiments, the method 1000 is performed in a digital medium environment that includes the structural merger system 900. The method 1000 is intended to be illustrative of one or more methods in accordance with the present disclosure and is not intended to limit potential embodiments. Alternative embodiments can include additional, fewer, or different steps than those articulated in FIG. 10.

As illustrated in FIG. 10, the method 1000 includes an act 1002 of receiving a document including multiple text elements. In some embodiments, the document is an unstructured document. An unstructured document includes data stored without metadata or a predetermined format. Examples of unstructured documents include portable document format (PDF) documents in which the data contained within the PDF lacks a predefined structure. For example, a PDF can include text, graphics, tables, charts, and more in a single file format. The PDF document can contain text elements such as paragraphs, sentences, headings, etc.

As illustrated in FIG. 10, the method 1000 includes an act 1004 of determining, by a machine learning model, a likelihood of merging a first text element with a second text element based on structure data and context data associated with the first and second text elements. For example, a heading manager employs two machine learning models to determine a likelihood of merging a candidate text heading (a first text element) with a target text heading (a second text element). For example, a first machine learning model is a language model that determines contextual data associated with the candidate text heading and the target text heading. A second machine learning model uses the contextual data determined by the first machine learning model and structural information (e.g., font information and distance information associated with the candidate text heading and target text heading) to determine a merge classification (e.g., a likelihood of merging the candidate text heading with the target text heading).

Additionally, a paragraph manager employs a single machine learning model to determine a likelihood of merging a candidate incomplete paragraph (a first text element) with a target incomplete paragraph (a second text element). The candidate incomplete paragraph and target incomplete paragraph are selected because (1) both the candidate incomplete paragraph and the target incomplete paragraph are incomplete paragraphs (determined using heuristic information such as full stop information) and (2) both the candidate incomplete paragraph and the target incomplete paragraph share structural attributes (determined by comparing structural information of the target incomplete paragraph and the candidate incomplete paragraphs contained in the PDF element ID and/or by comparing heuristics of the target incomplete paragraph and the candidate incomplete paragraphs). Accordingly, the determined likelihood of merging the candidate incomplete paragraph and the target incomplete paragraph is based on structural information. Subsequently, the first machine model (e.g., the language model described with respect to the heading manager) performs next sentence prediction using the contextual data determined as part of performing next sentence prediction. The output of the first machine learning model is a merge classification (e.g., a likelihood of merging the candidate incomplete paragraph with the target incomplete paragraph based on a next sentence prediction task).

As illustrated in FIG. 10, the method 1000 includes an act 1006 of determining that the likelihood of merging the first text element with the second text element satisfies a threshold. As described herein, a machine learning model determines a likelihood of each embedding received as part of an input vector satisfying a threshold (e.g., a “merge” threshold or a “do not merge” threshold). In some embodiments, a heading merger creates an input vector using received heading embeddings, target-candidate distance information, and candidate-font and target-font heading information, to classify each embedding as a first class (e.g., merge) or a second class (e.g., do not merge) responsive to the likelihood of the merge classification (or do not merge classification) satisfying a merge threshold (or a do not merge threshold).

As illustrated in FIG. 10, the method 1000 includes an act 1008 of merging the first text element with the second text element. For example, the first text element and the second text element may be headings such that the first heading and the second heading are merged. Additionally or alternatively, the first text element and the second text element may be paragraphs such that the first paragraph and the second paragraph are merged. In some embodiments, merging the first and second text elements include updating a PDF tag associated with the first text element and the second text element.

Embodiments of the present disclosure may comprise or utilize a special purpose or general-purpose computer including computer hardware, such as, for example, one or more processors and system memory, as discussed in greater detail below. Embodiments within the scope of the present disclosure also include physical and other computer-readable media for carrying or storing computer-executable instructions and/or data structures. In particular, one or more of the processes described herein may be implemented at least in part as instructions embodied in a non-transitory computer-readable medium and executable by one or more computing devices (e.g., any of the media content access devices described herein). In general, a processor (e.g., a microprocessor) receives instructions, from a non-transitory computer-readable medium, (e.g., a memory, etc.), and executes those instructions, thereby performing one or more processes, including one or more of the processes described herein.

Computer-readable media can be any available media that can be accessed by a general purpose or special purpose computer system. Computer-readable media that store computer-executable instructions are non-transitory computer-readable storage media (devices). Computer-readable media that carry computer-executable instructions are transmission media. Thus, by way of example, and not limitation, embodiments of the disclosure can comprise at least two distinctly different kinds of computer-readable media: non-transitory computer-readable storage media (devices) and transmission media.

Non-transitory computer-readable storage media (devices) includes RAM, ROM, EEPROM, CD-ROM, solid state drives (“SSDs”) (e.g., based on RAM), Flash memory, phase-change memory (“PCM”), other types of memory, other optical disk storage, magnetic disk storage or other magnetic storage devices, or any other non-transitory storage medium which can be used to store desired program code means in the form of computer-executable instructions or data structures and which can be accessed by a general purpose or special purpose computer.

A “network” is defined as one or more data links that enable the transport of electronic data between computer systems and/or modules and/or other electronic devices. When information is transferred or provided over a network or another communications connection (either hardwired, wireless, or a combination of hardwired or wireless) to a computer, the computer properly views the connection as a transmission medium. Transmissions media can include a network and/or data links which can be used to carry desired program code means in the form of computer-executable instructions or data structures and which can be accessed by a general purpose or special purpose computer. Combinations of the above should also be included within the scope of computer-readable media.

Further, upon reaching various computer system components, program code means in the form of computer-executable instructions or data structures can be transferred automatically from transmission media to non-transitory computer-readable storage media (devices) (or vice versa). For example, computer-executable instructions or data structures received over a network or data link can be buffered in RAM within a network interface module (e.g., a “NIC”), and then eventually transferred to computer system RAM and/or to less volatile computer storage media (devices) at a computer system. Thus, it should be understood that non-transitory computer-readable storage media (devices) can be included in computer system components that also (or even primarily) utilize transmission media.

Computer-executable instructions comprise, for example, instructions and data which, when executed at a processor, cause a general-purpose computer, special purpose computer, or special purpose processing device to perform a certain function or group of functions. In some embodiments, computer-executable instructions are executed on a general-purpose computer to turn the general-purpose computer into a special purpose computer implementing elements of the disclosure. The computer executable instructions may be, for example, binaries, intermediate format instructions such as assembly language, or even source code. Although the subject matter has been described in language specific to structural features and/or methodological acts, it is to be understood that the subject matter defined in the appended claims is not necessarily limited to the described features or acts described above. Rather, the described features and acts are disclosed as example forms of implementing the claims.

Those skilled in the art will appreciate that the disclosure may be practiced in network computing environments with many types of computer system configurations, including, personal computers, desktop computers, laptop computers, message processors, hand-held devices, multi-processor systems, microprocessor-based or programmable consumer electronics, network PCs, minicomputers, mainframe computers, mobile telephones, PDAs, tablets, pagers, routers, switches, and the like. The disclosure may also be practiced in distributed system environments where local and remote computer systems, which are linked (either by hardwired data links, wireless data links, or by a combination of hardwired and wireless data links) through a network, both perform tasks. In a distributed system environment, program modules may be located in both local and remote memory storage devices.

Embodiments of the present disclosure can also be implemented in cloud computing environments. In this description, “cloud computing” is defined as a model for enabling on-demand network access to a shared pool of configurable computing resources. For example, cloud computing can be employed in the marketplace to offer ubiquitous and convenient on-demand access to the shared pool of configurable computing resources. The shared pool of configurable computing resources can be rapidly provisioned via virtualization and released with low management effort or service provider interaction, and then scaled accordingly.

A cloud-computing model can be composed of various characteristics such as, for example, on-demand self-service, broad network access, resource pooling, rapid elasticity, measured service, and so forth. A cloud-computing model can also expose various service models, such as, for example, Software as a Service (“SaaS”), Platform as a Service (“PaaS”), and Infrastructure as a Service (“IaaS”). A cloud-computing model can also be deployed using different deployment models such as private cloud, community cloud, public cloud, hybrid cloud, and so forth. In this description and in the claims, a “cloud-computing environment” is an environment in which cloud computing is employed.

FIG. 11 illustrates, in block diagram form, an exemplary computing device 1100 that may be configured to perform one or more of the processes described above. One will appreciate that one or more computing devices such as the computing device 1100 may implement the structural merger system. As shown by FIG. 11, the computing device can comprise a processor 1102, memory 1104, one or more communication interfaces 1106, a storage device 1108, and one or more I/O devices/interfaces 1110. In certain embodiments, the computing device 1100 can include fewer or more components than those shown in FIG. 11. Components of computing device 1100 shown in FIG. 11 will now be described in additional detail.

In particular embodiments, processor(s) 1102 includes hardware for executing instructions, such as those making up a computer program. As an example, and not by way of limitation, to execute instructions, processor(s) 1102 may retrieve (or fetch) the instructions from an internal register, an internal cache, memory 1104, or a storage device 1108 and decode and execute them. In various embodiments, the processor(s) 1102 may include one or more central processing units (CPUs), graphics processing units (GPUs), field programmable gate arrays (FPGAs), systems on chip (SoC), or other processor(s) or combinations of processors.

The computing device 1100 includes memory 1104, which is coupled to the processor(s) 1102. The memory 1104 may be used for storing data, metadata, and programs for execution by the processor(s). The memory 1104 may include one or more of volatile and non-volatile memories, such as Random Access Memory (“RAM”), Read Only Memory (“ROM”), a solid state disk (“SSD”), Flash, Phase Change Memory (“PCM”), or other types of data storage. The memory 1104 may be internal or distributed memory.

The computing device 1100 can further include one or more communication interfaces 1106. A communication interface 1106 can include hardware, software, or both. The communication interface 1106 can provide one or more interfaces for communication (such as, for example, packet-based communication) between the computing device and one or more other computing devices 1100 or one or more networks. As an example and not by way of limitation, communication interface 1106 may include a network interface controller (NIC) or network adapter for communicating with an Ethernet or other wire-based network or a wireless NIC (WNIC) or wireless adapter for communicating with a wireless network, such as a WI-FI. The computing device 1100 can further include a bus 1112. The bus 1112 can comprise hardware, software, or both that couples components of computing device 1100 to each other.

The computing device 1100 includes a storage device 1108 includes storage for storing data or instructions. As an example, and not by way of limitation, storage device 1108 can comprise a non-transitory storage medium described above. The storage device 1108 may include a hard disk drive (HDD), flash memory, a Universal Serial Bus (USB) drive or a combination these or other storage devices. The computing device 1100 also includes one or more input or output (“I/O”) devices/interfaces 1110, which are provided to allow a user to provide input to (such as user strokes), receive output from, and otherwise transfer data to and from the computing device 1100. These I/O devices/interfaces 1110 may include a mouse, keypad or a keyboard, a touch screen, camera, optical scanner, network interface, modem, other known I/O devices or a combination of such I/O devices/interfaces 1110. The touch screen may be activated with a stylus or a finger.

The I/O devices/interfaces 1110 may include one or more devices for presenting output to a user, including, but not limited to, a graphics engine, a display (e.g., a display screen), one or more output drivers (e.g., display drivers), one or more audio speakers, and one or more audio drivers. In certain embodiments, I/O devices/interfaces 1110 is configured to provide graphical data to a display for presentation to a user. The graphical data may be representative of one or more graphical user interfaces and/or any other graphical content as may serve a particular implementation.

In the foregoing specification, embodiments have been described with reference to specific exemplary embodiments thereof. Various embodiments are described with reference to details discussed herein, and the accompanying drawings illustrate the various embodiments. The description above and drawings are illustrative of one or more embodiments and are not to be construed as limiting. Numerous specific details are described to provide a thorough understanding of various embodiments.

Embodiments may include other specific forms without departing from its spirit or essential characteristics. The described embodiments are to be considered in all respects only as illustrative and not restrictive. For example, the methods described herein may be performed with less or more steps/acts or the steps/acts may be performed in differing orders. Additionally, the steps/acts described herein may be repeated or performed in parallel with one another or in parallel with different instances of the same or similar steps/acts. The scope of the invention is, therefore, indicated by the appended claims rather than by the foregoing description. All changes that come within the meaning and range of equivalency of the claims are to be embraced within their scope.

In the various embodiments described above, unless specifically noted otherwise, disjunctive language such as the phrase “at least one of A, B, or C,” is intended to be understood to mean either A, B, or C, or any combination thereof (e.g., A, B, and/or C). As such, disjunctive language is not intended to, nor should it be understood to, imply that a given embodiment requires at least one of A, at least one of B. or at least one of C to each be present.

We claim:

1. A method comprising:
receiving a document including a plurality of text elements;
determining, by a machine learning model, a likelihood of merging a first text element of the plurality of text elements with a second text element of the plurality of text elements based on structure data and context data associated with the first and second text elements;
determining whether the likelihood of merging the first text element with the second text element satisfies a threshold; and
responsive to determining that the likelihood of merging the first text element with the second text element satisfies the threshold, merging the first text element with the second text element.

2. The method of claim 1, wherein the plurality of text elements include a plurality of headings, and wherein the first text element is a candidate heading and the second text element is a target heading.

3. The method of claim 2, wherein the structure data associated with the first and second text elements includes a font of the candidate heading and a font of the target heading.

4. The method of claim 2, wherein the structure data associated with the first and second text elements includes a distance between the candidate heading and the target heading.

5. The method of claim 4, further comprising:
receiving a candidate bounding box including the candidate heading;
receiving a target bounding box including the target heading; and
determining a distance between a center of the candidate bounding box and a center of the target bounding box to obtain the distance between the candidate heading and the target heading.

6. The method of claim 2, wherein the context data associated with the first and second text elements includes:
a candidate heading embedding generated by a language machine learning model based on the candidate heading; and
a target heading embedding generated by the language machine learning model based on the target heading.

7. The method of claim 1, wherein the plurality of text elements include a plurality of paragraphs, and wherein the first text element is a candidate incomplete paragraph and the second text element is a target incomplete paragraph.

8. The method of claim 7, wherein the candidate incomplete paragraph and the target incomplete paragraph share one or more structural attributes.

9. The method of claim 7, wherein the context data associated with the first and second text elements includes:
a candidate incomplete paragraph embedding generated by the machine learning model based on the candidate incomplete paragraph, and
a target incomplete paragraph embedding generated by the machine learning model based on the target incomplete paragraph.

10. The method of claim 1, wherein the likelihood of merging the first text element of the plurality of text elements with the second text element of the plurality of text elements is determined based on the structure data and the context data associated with the first and second text elements.

11. A non-transitory computer-readable medium storing executable instructions, which when executed by a processing device, cause the processing device to perform operations comprising:
receiving a document including a candidate text element and a target text element;
classifying the candidate text element as a text element to be merged responsive to a merge likelihood satisfying a threshold, wherein the merge likelihood is based on a structure of the candidate text element and the target text element and a context of the candidate text element and the target text element;
updating a tag associated with at least one of the candidate text element or the target text element; and
obtaining a merged document using the updated tag.

12. The non-transitory computer-readable medium of claim 11, wherein classifying the candidate text element as the text element to be merged, further causes the processing device to perform operations comprising:
determining, by a language machine learning model, a candidate heading embedding and a target heading embedding based on a candidate heading and a target heading, wherein the candidate heading is the candidate text element and the target heading is the target text element; and
determining, by a machine learning model, the merge likelihood based on a structure of the candidate heading and the target heading, and the candidate heading embedding and the target heading embedding.

13. The non-transitory computer-readable medium of claim 12, wherein the structure of the candidate heading and the target heading includes a font of the candidate heading and a font of the target heading.

14. The non-transitory computer-readable medium of claim 12, wherein the structure of the candidate heading and the target heading includes a distance between the candidate heading and the target heading.

15. The non-transitory computer-readable medium of claim 11, wherein classifying the candidate text element as the text element to be merged, further causes the processing device to perform operations comprising:
determining, by a language machine learning model, the merge likelihood based on a structure of a candidate paragraph and a target paragraph, and a context of the candidate paragraph and the target paragraph, wherein the candidate paragraph is the candidate text element and the target paragraph is the target text element.

16. The non-transitory computer-readable medium of claim 15, wherein the context of the candidate paragraph and the target paragraph is determined using the language machine learning model, wherein the context of the candidate paragraph is a candidate paragraph embedding and the context of the target paragraph is a target paragraph embedding.

17. The non-transitory computer-readable medium of claim 16, storing instructions that further cause the processing device to perform operations comprising:
determining, by the language machine learning model, the candidate paragraph embedding and the target paragraph embedding based on the target paragraph and the candidate paragraph, wherein the target paragraph and the candidate paragraph are each incomplete text paragraphs and share one or more structural attributes.

18. A system comprising:
a memory component; and
a processing device coupled to the memory component, the processing device to perform operations comprising:
receiving a document including a plurality of text elements;
determining, by a machine learning model, a likelihood of merging a first text element of the plurality of text elements with a second text element of the plurality of text elements based on structure data and context data associated with the first and second text elements;
determining whether the likelihood of merging the first text element with the second text element satisfies a threshold; and
responsive to determining that the likelihood of merging the first text element with the second text element satisfies the threshold, merging the first text element with the second text element.

19. The system of claim 18, wherein the plurality of text elements include a plurality of headings, and wherein the first text element is a candidate heading and the second text element is a target heading.

20. The system of claim 18, wherein the plurality of text elements include a plurality of paragraphs, and wherein the first text element is a candidate incomplete paragraph and the second text element is a target incomplete paragraph.
